(19) United States
(12) Patent Application Publication
(10) Pub. No.: US 2007/0286642 A1
(43) Pub. Date: Dec. 13, 2007

(54) Method for fabricating a contact cleaning roller or belt

(76) Inventors: Frank C. Corrado, Rochester, NY (US); Gary R. Larsen, Webster, NY (US); Ronald W. Sweet, Conesus, NY (US); James W. Fischer, Rochester, NY (US)

Correspondence Address: Ronald J. Kisicki, Esq.;Jaeckle Fleischmann & Mugel, LLP, 190 Linden Oaks, Rochester, NY, 14625-2812, US

(21) Appl. No.: 11/811,457

(22) Filed: Jun. 11, 2007

Related U.S. Application Data
(60) Provisional application No. 60/813,188, filed on Jun. 13, 2006.

(51) Int. Cl. G03G 15/20

(52) U.S. Cl. 399/123

(57) ABSTRACT

A contact cleaning roller or belt fabricated by attaching a polymer-coated flexible substrate cut from flexible sheet stock to the surface of a structural core or a structural belt of a desired length. For either a CCR or CCB, an adhesive and/or resilient layer may be inserted between the flexible substrate and the structural element. The flexible substrate may be formed of metal, for example, aluminum, or plastic, for example, polyethylene terephthalate and may comprise, for example, a toothed belt having a smooth outer surface. The flexible substrate is provided with a polymeric layer having low durometer and triboelectric properties, such as novolak resin, cross-linked epoxides, polyisoprene rubber, silicone rubber, polyurethane, and norbornene-co-styrene-co-maleic anhydride. An advantage of a CCR or CCB in accordance with the invention is that the substrate and polymeric layer are easily replaced to provide a refurbished CCR or CCB.

### RELATIONSHIP TO OTHER APPLICATIONS AND PATENTS

This application draws priority from a pending U.S. Provisional Patent Application, Ser. No. 60/813,188, filed Jun 13, 2006.

### TECHNICAL FIELD

The present invention relates to apparatus for cleaning particles from a substrate; more particularly, to a polymer-covered contact cleaning roller or belt; and most particularly, to method and apparatus for fabricating a contact cleaning device such as a roller or belt.

### BACKGROUND OF THE INVENTION

Contact cleaning rollers and belts, also known in the art as particle transfer devices, are well known aids in the cleaning of particles from web and roller substrate surfaces. For simplicity of presentation, as employed herein the term “contact cleaning roller” also should be taken to mean “contact cleaning belt” except where differences therebetween are specifically addressed. A contact cleaning roller (CCR) is a cylindrical device that rolls along the surface to be cleaned and attracts to its own surface particles present on the surface to be cleaned. A contact cleaning belt (CCB) is a linear device formed typically as an endless loop and conveyed in use on rollers. A CCB also cleans by contact removal of particles from a surface.

Prior art CCRs generally employ either an adhesive surface, formed typically by the winding of an adhesive tape face out on an inert mandrel or core, or a triboelectric polymeric outer layer formed onto an inert mandrel or core. The latter type of CCR typically is formed in the prior art by the method of overmold casting of the polymer onto the core, followed by lathe turning of the molded outer layer to true the surface for use. This method is time-consuming, relatively expensive, and requires a mold large enough to hold the entire CCR. Such CCRs are known in the art to be in excess of ten feet in length and one foot in diameter.

Prior art CCBs typically are formed by slitting a belt-shaped element from sheet stock comprising a flexible substrate that has been coated on one side with an appropriate polymeric material, and attaching the belt ends together. One problem with such a prior art forming process is that CCB applications are then limited by the durability and viscoelastic properties of the substrate material as well as those of the polymeric material. Another problem is that belt length is limited by the overall length of the parent sheet material.

What is needed in the art is an improved method and apparatus for forming a polymer-covered CCR or CCB that does not require molding or construction of a mold, that is not restricted by overall length of the parent sheet material, and that affords a broad selection of substrate materials.

It is a principal object of the present invention to increase the number of optional methods and materials for constructing a contact cleaning roller or a contact cleaning belt.

### SUMMARY OF THE INVENTION

Briefly described, a contact cleaning roller is fabricated by attaching a polymer-coated flexible substrate to the surface of a structural metal mandrel. Similarly, a contact cleaning belt is formed by attaching a belt-shaped polymer-coated flexible substrate to one surface of a flexible structural belt of a desired length. For either a CCR or CCB, an adhesive and/or resilient layer may be inserted between the flexible substrate and the structural element. The flexible substrate may be formed of a sheet of metal, for example, aluminum, or a sheet of plastic, for example, polyethylene terephthalate and may comprise, for example, a toothed belt having a smooth outer surface. On a surface away from the CCR or CCB surface, the flexible substrate is provided with a low durometer polymeric layer having triboelectric properties. Exemplary materials suitable for the polymeric layer include, but are not limited to, novolak resin, cross-linked epoxides, polyisoprene rubber, silicone rubber, polyurethane, and norbornene--co-styrene-co-maleic anhydride.

An advantage of a CCR or CCB formed in accordance with the present invention is that the substrate and polymeric layer are easily removed and replaced in an ordinary shop, to provide a refurbished CCR or CCB; whereas, in the prior art, the entire polymeric layer must be removed from a mandrel or belt which is then recast in a specialty molding facility, at considerably greater time and cost.

### BRIEF DESCRIPTION OF THE DRAWINGS

The present invention will now be described, by way of example, with reference to the accompanying drawings, in which:

FIG. 1 is a cross-sectional view of a CCR formed in accordance with the invention;

FIG. 2 is a schematic elevational view of a substrate cleaning facility employing a CCB formed in accordance with the invention; and

FIG. 3 is a detailed cross-sectional view of the CCB area shown in Circle 3 in FIG. 2.

### DESCRIPTION OF THE PREFERRED EMBODIMENTS

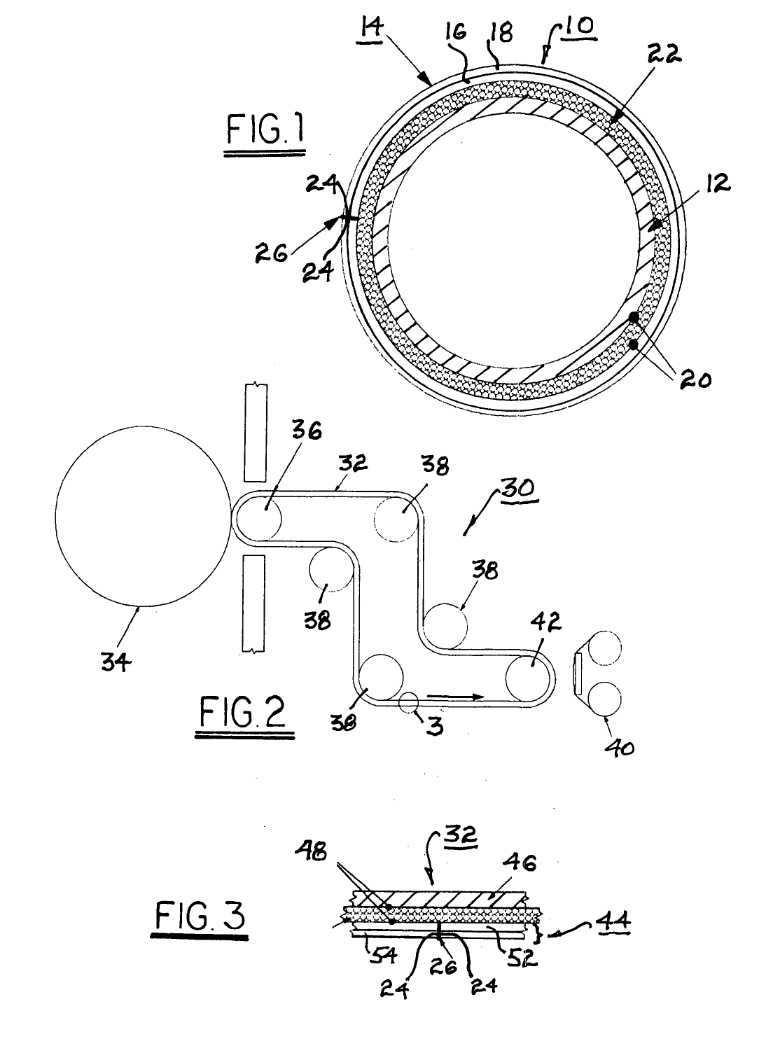

Referring to FIG. 1, a contact cleaning roller 10 is formed in accordance with the present invention. CCR 10 comprises a hollow cylindrical mandrel or core 12 surrounded by a cleaning element 14 comprising a flexible substrate 16 and a polymeric outer layer 18 bonded to substrate 16. Preferably the outer surface of mandrel 12 and the inner surface of cleaning element 14 are provided with adhesives 20 such as adhesive coatings or double-faced tape. Preferably but optionally, a resilient layer 22, formed, for example, of a foam or rubber polymer, may be included between flexible substrate 16 and core 12 to allow the cleaning surface of outer layer 18 to conform to minor irregularities in a surface being cleaned.

In a first exemplary method for forming a CCR, cleaning element 14 is cut from sheet stock (not shown) to a length equal to the circumference of core 12 and is formed into a tube having an inner diameter equal to the outer diameter of the core, the ends 24 of the cut sheet being secured to each other in a seam 26 by, for example, adhesives or laser welding. The tube is then slid onto core 12 and secured thereupon by adhesives 20, which may be emplaced on the core and tube surfaces prior to introduction of the tube onto the core.

In a second exemplary method, a length of sheet stock longer than the circumference of the core is wrapped tightly around the core with the ends overlapping. A razor knife or other sharp instrument is then used to cut the wrapped sheet stock in the overlapping region to produce, after end discards, a cleaning element of length exactly equal to the circumference of the core. The cleaning element is then attached to the core surface as by adhesives 20, with the free ends abutting. The joint 26 between the two free ends may be smoothed by application of a liquid material, preferably a monomer of the polymer forming polymeric outer layer 18, which monomer may then be polymerized or otherwise hardened in known fashion.

Referring to FIGS. 2 and 3, a typical substrate cleaning facility 30 employing a CCB 32 formed in accordance with the invention for cleaning the surface of a roller 34 includes a first backing roller 36 for supporting CCB 32 against roller 34; a plurality of conveyance rollers 38 which may also be tensioning rollers for maintining tension in belt 32; a cleaning station 40 for rejuvenation of CCB 32 such as is shown typically for a CCR in U.S. Pat. No. 5,611,281 which is incorporated herein by reference; and a second backing roller 42 for urging CCB 32 against cleaning station 40 when belt rejuvenation is desired.

CCB 32 is formed by attaching a belt-shaped polymer-coated flexible cleaning element 44 to one surface of a flexible structural belt 46 of a desired length. As in forming a CCR, adhesives 48 are applied to cleaning element 44 and to structural belt 46, and an optional resilient layer 50 also may be included between cleaning element 44 and structural belt 46. Structural belt 46 may comprise, for example, a toothed belt having a smooth outer surface.

Cleaning element 44 comprises a flexible substrate 52 that may be formed of a sheet of metal, for example, aluminum, or a sheet of plastic, for example, polyethylene terephthalate. Flexible substrate 52 is provided with a low durometer polymeric layer 54 having triboelectric properties, similar or identical to outer layer 18 described above for a CCR. In fact, the flexible sheet stock used for forming CCR 10 generally may also be used for forming CCB 32. Closing and sealing joint 26 of butt ends 24 is the same as for forming a CCR.

Note that a significant advantage of forming a CCB in accordance with the present method is that long belts may easily be formed by employing sequential sections of cleaning element 44.

In a preferred method for forming a CCB in accordance with the invention, the structural belt 46 is positioned in use configuration and the cleaning element 44 is cut and fastened to the belt in this position. This procedure accommodates the difference in overall length imposed by laminating the cleaning element to the outside of an endless loop and therefore prevents delaminating stresses in passing the CCB 32 around rollers 38.

A currently preferred cleaning element sheet stock for forming either a CCR 10 or a CCB 32 is Twinlock® material, available from Polymount Corporation in 0.060″ and 0.020″ thickness. This material has a tacky surface layer comprising a photopolymer which is UV cross-linkable. Joints are sealable with liquid photopolymer. Isopropanol or Twinlock cleaner may be used to clean and tack-up the surface; other solvents are not advisable and may enter the joint and cause delamination of the substrate from the roller surface. Cleaning with water presents no problem. Minimum diameter of a roller, either a core for forming a CCR or a roller for conveying a CCB, is about 3″.

While the invention has been described by reference to various specific embodiments, it should be understood that numerous changes may be made within the spirit and scope of the inventive concepts described. Accordingly, it is intended that the invention not be limited to the described embodiments, but will have full scope defined by the language of the following claims.

What is claimed is:

1. A contact cleaning device, comprising:
a) a structural substrate having an outer surface; and
b) a flexible cleaning element formed from a flexible sheet stock and conformal to said outer surface and having self-abutting ends, wherein said flexible cleaning element includes an outer layer formed of a polymer defining a cleaning surface for said contact cleaning device.

2. A contact cleaning device in accordance with claim 1 wherein said flexible cleaning element further includes a flexible substrate selected from the group consisting of a metal sheet and a plastic sheet.

3. A contact cleaning device in accordance with claim 1 wherein said polymer is selected from the group consisting of novolak resin, cross-linked epoxides, polyisoprene rubber, silicone rubber, polyurethane, and norbornene-co-styrene-co-maleic anhydride.

4. A contact cleaning device in accordance with claim 1 wherein said structural substrate is a cylindrical core and said contact cleaning device is a contact cleaning roller.

5. A contact cleaning device in accordance with claim 1 wherein said structural substrate is an endless belt and said contact cleaning device is a contact cleaning belt.

6. A contact cleaning device in accordance with claim 1 further comprising a resilient layer between said structural substrate and said flexible cleaning element

7. A method for forming a contact cleaning device, comprising the steps of:
a) forming a structural substrate having an outer surface;
b) forming a flexible cleaning element from a flexible sheet stock having an outer layer formed of a polymer;
c) conforming said flexible cleaning element to said outer surface such that said flexible cleaning element overlaps itself over a portion thereof;
d) cutting through both layers of said flexible cleaning element in said overlapping portion to form an attachable portion and at least one waste portion;
e) removing said waste portion; and
f) attaching said attachable portion to said outer surface such that cut ends thereof from said cutting step are self-abutted to form a joint therebetween.

8. A method in accordance with claim 7 comprising the further step of applying a liquid material to fill said joint.

9. A method in accordance with claim 7 wherein said contact cleaning device is a contact cleaning roller, and wherein said structural substrate is a cylindrical core.

10. A method in accordance with claim 7 wherein said contact cleaning device is a contact cleaning belt, and wherein said structural substrate is an endless belt.

11. A method for forming a contact cleaning device, comprising the steps of:
a) forming a structural substrate having an outer surface;
b) forming a flexible cleaning element from a flexible sheet stock having an outer layer formed of a polymer;
c) cutting said flexible cleaning element to a length substantially equal to the circumference of said structural substrate;
d) joining together the ends of said cut length of flexible cleaning element to form a tubular element having a diameter substantially equal to the circumference of said structural substrate; and
e) sliding said tubular element axially over said structural substrate to a predetermined axial position thereupon.

12. A method in accordance with claim 11 comprising the further step of securing said tubular element to said mandrel.

13. A method in accordance with claim 11 wherein said contact cleaning device is a contact cleaning roller, and wherein said structural substrate is a cylindrical core.

14. A method in accordance with claim 11 wherein said contact cleaning device is a contact cleaning belt, and wherein said structural substrate is an endless belt.
